(19) United States
(12) Patent Application Publication
(10) Pub. No.: US 2010/0108092 A1
(43) Pub. Date: May 6, 2010

(54) Ultrasonic powered sugarbeet and cut sugar cane cleaning method using a stainless steel flume

(75) Inventor: Leon Edward Zaharis, Ithaca, NY (US)

Correspondence Address: LEON EDWARD ZAHARIS, 1398 MECKLENBURG RD., ITHACA, NY, 14850-9389, US

(73) Assignee: Leon Edward Zaharis, Ithaca, NY (US)

(21) Appl. No.: 12/290,909

(22) Filed: Nov. 5, 2008

(51) Int. Cl. B08B 3/12

(52) U.S. Cl. 134/1

(57) ABSTRACT

An improved method of cleaning topped/scalped sugar beets and field chopped sugar cane cuttings using ultrasonic energy by the utilization of water used to transport and clean the topped/scalped sugar beets, beet pieces, beet slices, beet noodles, and chopped sugar cane using a plurality of ultrasonic emitters lining the walls and floor of its entire length for its entire length.

### CROSS REFERENCE TO RELATED APPLICATIONS

Not Applicable

### BACKROUND

1. Field of Invention

This new use patent invention directly relates to the use of cold water pre-cleaning of topped sugar beets and sugar cane cuttings using ultrasonic energy and a stainless steel flume to remove all the dirt clinging to the topped sugar beet root and chopped sugar cane.

2. Description of Prior Art

The sugar beet is the result of French emperor Napoleon Bonapart's need to bypass the british blockade of France which eliminated his ability to obtain sugar and molasses from the French-owned islands in the Caribbean where all their sugar was obtained. The sugar beet was selectively bred from its parent, the sea beet. The modern sugar beet is a root crop that has been continually genetically improved through selective breeding to reduce the number of root hairs normally present on the beet root, thereby creating a smoother beet root which in turn reduces the amount of dirt clinging to the beet root at harvest. Much dirt remains on the root which must be removed prior to the slicing of the beets, processing them using an in plant washing flume removing some of the dirt out of the wash water, and the remaining dirt is removed with the settled sludges from the raw juice extraction process. This is why my new use patent invention is so important as it eliminates all the dirt before the sugar beet enters the sugar beet factory or cane cuttings into the sugar cane mill, which is something that is not being done today and will save millions of dollars in mud sludge disposal costs, hundreds of hours of labor costs in dealing with dirt and sludges from waste sugar their sanitary disposal and thereby reducing to near zero the decomposition odors from the waste water sludge stored in lagoons on the sugar factory's properties. The sugar cane mills will also benefit greatly as they will not have to deal with any dirt or mud entering the sugar mills from the sugar cane cuttings or that must be ground prior to processing into raw sugars and molasses. The sugar cane grown in the United States is harvested mechanically using self propelled cane harvesters that are either track mounted or rubber tired. The sugar cane plant is cut whole at the base of the plant, and carried into the chopper mechanism with a dual set of augers mounted in each row of the harvester head for each row of sugar cane, where the sugar cane is chopped and blown into a receiving wagon towed by the harvester after which it is either dumped at the end of the field to be loaded later into a truck or dumped directly into a waiting truck and delivered to the sugar cane mill. Sugar cane is also harvested as whole stalk and loaded and unloaded with a cane grapple. Sugar cane is also a crop with dirt problems due to the constant handling, and re-handling and dumping it on the ground where it also collects dirt, stones and mud that must be removed and disposed of. The growing and processing of sugar beets and sugar cane into useable raw sugars, molasses, beet pulp and sugar cane bagasse waste is a seasonal crop enterprise due to our geographic location and shorter growing season. The growing season for sugar beets can vary, as they are grown for 4 to 5 months in the eastern and Midwestern United States and for 8 months in the California growing areas prior to harvesting. The freshly topped (leaves and stems removed) harvested sugar beets are either taken directly to the piling station for weighing to determine gross, tare and net weight, sample testing for sugar content, and stock piling at the piling station or directly to the sugar refinery for weighing to determine the gross weight, net weight and tare weight, and testing for the beets sugar content and then either stock piling the beets directly on the individual sugar factory property to await processing or dumping them directly in the receiving hopper of the factory during the short harvest period. The sugar beets are stored in long cylindrically shaped piles to allow faster cooling of the dirty beets during stock piling at the piling stations or sugar factory. Many growers are harvesting their sugar beets at night to reduce heat stress on the sugar beets and improve the amount of recoverable sugars. The representative tare weight of each load is the amount of dirt that is collected from the 50 pound sample of sugar beets removed from the truck delivering the sugar beet load to the scale house. This weight is deducted from the total weight of the delivered beets, reducing the net amount paid to the grower in his or her quarterly acreage share payment after the growing season. This why my new use patent invention is so important, as it totally eliminates the tare weight dirt discount from the sugar beet loads and by doing so increases the gross income to the individual sugar beet grower and eliminates the cost of dirt and its disposal at the sugar beet factory or sugar cane mm, increasing the net incomes for the cooperatives and their owners. My new use patent invention will also eliminate any heat build up in the harvested beet root, as any dirt clinging to the root acts as an insulator and the heat held by the dirt acts to degrade the harvested beet root, and its sugar content by spoilage from overheating this affects the cellular core of the beet root rather than letting the beet cool down after the immediate harvest. My new use patent invention will also remove any remaining clinging bacteria from the beet root as well due to the thorough cleaning of the sugar beet root due to the bubbles generated by the ultrasonic energy used. Doing this will increase the storage life of the beet root in the stock pile and reduce losses from spoilage from heat, and all the crop can be harvested and safely stored at the piling station or sugar factory stockpile until it is processed. The sugar beet is a root crop that may be planted on flat ground or in hill method, which is referred to as ridge tillage and it may be an irrigated crop depending upon the growing area. Today, the humble sugar beet is harvested using high horsepower tractors towing a harvester powered by the individual tractor's power take off. The tractor's hydraulic system may or may not be used to power the harvesters steering and unloading system. The harvester may have its own hydraulic pump, reservoir and hydraulic system that may be powered by the individual harvester's power take off shaft from the tractors power take off unit or PTO as it is referred to. There are a substantial number of companies building towed sugar beet harvesting machines as well. There are at least three manufacturers of self-propelled sugar beet harvesters currently available worldwide and a self-propelled beet-reclaiming machine to gather stock piled beets for loading into trucks as well. The sugar beet harvest begins with the topping of the beets where a beet flail or scalper as it also referred to cuts the stems and top off the beet root prior to harvesting. A sugar beet harvester towed by a tractor is then brought in behind the beet flail or scalper, as it is commonly referred to. Each individual row of the harvester has a pair of puller rings to physically grab, and lift the beets out of the ground. The act of lifting the topped beet raises it to a roller bed conveyor, where the gap on the pair of puller rings allows the topped beet to fall on the roller bed or lifting wheel, which removes some of the dirt and roll's the harvested sugar beet to a either a lifting wheel or open chain conveyor which delivers the beets to the receiving tank whereby it is dumped when the tank is full, or the sugar beets may be harvested, and continuously unloaded into a waiting truck moving at the same speed as the harvester. The sugar beet industry in the United States has advanced considerably from the day when the sugar beets were manually planted in hills, weeded by hand, harvested by hand using a potato fork, topped by hand, and then loaded into a horse or mule drawn wagons. Then the wagons were driven to the sugar factory, emptied and returned for the next load during the daylight hours. Sugar beets are grown using a 4-year rotation with 3 other crops. Recently, several researchers have found that growing the sugar beet in a 5-year crop rotation has had a huge positive effect in higher sugar beet root tonnage and sugar yields. Initially, the slicing campaign in the sugar beet factory will begin slowly to find problems and repair them before the 7-day around the clock production begins. It occurs after the complete harvest and stock piling at the piling stations and sugar factories has been completed. This is usually occurs in late October or early November depending upon late rains or ground freezing and the weather in general. If the weather turns warmer, The un-flailed beets will continue to grow. During warmer weather the sugar beet stockpiles are sprayed with a milk of lime solution to coat it with a white blanket to keep the piles cool and to reflect the suns rays. This milk of lime solution is also the same solution used to extract the raw sugar juice, is it sprayed on the beet piles with cold water to create a white blanket on the stock piles to reflect the suns rays. Cooling mats are also used to help keep the pile temperature lower and maintain recoverable sugars rather than allow the beets to deteriorate prematurely. Wherein my new use patent invention utilizing ultrasonic energy much more thoroughly cleans the topped sugar beets, and sugar cane using the air bubbles created by the ultrasonic waves generated from the emitters in the water to better clean the topped beets and chopped sugar cane to scrub them of any dirt, mud, clay or naturally present bacteria. Doing this obtains a superior cleaning of the topped sugar beet root prior to stockpiling, and removes the dirt clinging to the topped sugar beet root, whereby it will improve the storage life of the topped sugar beet root. Any clinging dirt, mud, or clay remaining will act as an insulator retaining the natural heat present in the topped sugar beet that will reduce the natural sugar content of the individual sugar beet, and prevent a faster cooling down of the beet root. The ultrasonic cleaning of the topped sugar beet root will also remove any bacteria clinging to the beet root as an added benefit, thus improving its storage life even further by eliminating the bacteria from the topped sugar beet roots skin prior to stock piling or immediate processing. The slicing of the sugar beets is referred to as the slicing campaign, may begin early if the anticipated harvest is considerable or when all the stockpiles at the piling stations and factory are nearly full in the individual factory area. Some sugar beets are lost due to over production and may end up being plowed under due to the sugar factories inability to handle them all. My new use patent method will eliminate any need to plow under any more of the sugar beet crop and its subsequent monetary loss to the individual sugar beet farmer and his or her sugar beet cooperative. At the individual sugar beet factory, several front end loaders are used to stockpile incoming beets, remove the stockpiled beets from existing stock piles, reclaim and carry loads soft of coal, previously delivered by unit coal trains, from the coal stock piles on the sugar refinery property to the sugar refineries coal storage hoppers, which feed the individual boilers used to make steam and hot water. A front-end loader is also used to dump agricultural lime into the mixing hoppers for the manufacture of the hot water milk of lime solution used to extract the raw sugar juice. The sugar beet slices are referred to as noodles as they are sliced in such a way to create a wavy texture to allow more efficient extraction of the raw sugar juices in the hot milk of lime solution. A front-end loader is also used to remove coal ashes from the coal boilers to an ash storage area. The front-end loader is used to remove the lime sludges generated by the milk of lime solution. A front-end loader is also used to remove and stock pile the pressed and dried sugar beet pulp from the factory, which goes into bulk storage for later packaging and sale for animal feeds or waste if there is no market for it. A sugar cane mill will process either whole sugar cane with a sugar cane grapple to move the cane into the grinder or chopped sugar cane cuttings. The sugar cane mills use the same method of sucrose extraction as sugar beet factories and they will also use coal or natural gas for fuel or sugar cane bagasse waste, which is the waste left from extraction of sucrose from sugar cane. My new use method patent will allow for a longer and safer storage life of the harvested sugar beet prior to processing as the dirt will no longer be there to hold any residual heat or dirt borne bacteria. Due to the seasonal nature of the sugar beet crop the typical sugar beet refinery is small and can only slice and extract a small tonnage of raw sugars and molasses per 24-hour day of production. The produced raw sugars are conveyed to storage silos on site for further processing/refining and packaging later in the year. A sugar beet factory will have generally a coal fired or natural gas steam boiler system to make steam, hot water, milk of lime solutions and generate electricity for the factories use during the months it is slicing and extracting raw sugar juices, unrefined sugars and molasses. The boiler systems are smaller as they do not run year round to slice and extract raw sugars. Since the topped sugar beets or sugar cane will have been cleaned by my new use patent invention, the water used to convey the sugar beet from the factories receiving hopper to the slicers or cane grinders will have no dirt in it, and will not prematurely wear out the beet pumps impeller, the shaft seals, the pump chamber volute and impeller will not be pitted with rock damage, and the pump will not have the added weight of ten percent of the typical sugar beet crops tonnage in dirt to pump as an added benefit. In addition dirt will no longer collect in the existing in plant washing flume (which is used to convey the topped sugar beets to the slicers) or also in the juice diffusers and need to be removed at intervals. With the dirt removed from the topped sugar beets and conveying water, the beet slicers will not have to be shut down to change the beet slicing knives, as they will not be nicked by stones and have dull worn cutting edges due to dirt clinging to the beet prior to the slicing process. The raw juice diffusers will not have to cope with dirt entering the diffusers from the sliced beet noodles improving their collective efficiency as no dirt will be pumped with the milk of lime solutions while extracting the raw beet juice. In the case of sugar cane crushers and grinders they will not require resurfacing as often as there will be no dirt entering the crushers and grinders. In addition, my new use patent will save energy, reduce water use, and water treatment chemical costs for the sugar refinery, thereby generating huge savings in factory overhead costs from reduced expenditures in plant maintenance, and it will reduce the need for sugar imports, as a larger sugar beet crop can be grown with no difficulty from storage losses. My new use patent invention will allow for a larger crop of sugar beets to be grown, that can be used for the distillation of alcohol from sugar beets to make steam, and generate electricity to sell as an added benefit for the sugar beet co-op members in addition to increasing their incomes by growing bigger crops and the benefiting the local communities with further spending during the entire year. When the slicing campaign has ceased in February, March or early April due to the finishing of beet slicing, the entire crop and with all the raw sugars and molasses having been extracted is stored in the factory's vertical sugar silos and liquid storage tanks. The slicers have been shut down for the season and any maintenance that is required is done. The rest of the production year the remaining employees refine, dry, package and warehouse the sugar produced from the slicing campaign. My new use patent method will allow for a longer slicing campaign and bigger sugar beet crops as spoilage of sugar beets in the stockpile will no longer be a problem as all the dirt will be removed from the sugar beets prior to stock piling the beets. For the benefit of the reader I have provided several documents related to the harvest and processing of sugar beets, several advertisements describing and illustrating sugar beet harvesting machines, documents describing the flow and processing of sugar beets in a sugar beet factory. In accordance with the present invention, ultrasonic energy is used in combination with cold water to better clean topped sugar beet roots prior to both long term storage, the immediate processing of the topped sugar beets, also including the immediate processing of cut, chopped sugar cane prior to entering the sugar cane mill for extracting raw juice, molasses and various sugars made from the sugar cane plant. My new use patent invention will remove all dirt before it enters the sugar beet factory, and sugar cane mill and it will eliminate the in plant maintenance problems related to dirt and mud from these two valuable crops that must be dealt with on a daily basis during the harvest, and after the harvest during the raw sugar extraction phase of sucrose extraction. Removing the dirt prior to slicing of the sugar beets and crushing of the sugar cane will eliminate dirt and mud in the individual sugar refinery's water sytem, which is used to physically move the crops through the plant for raw juice extraction. The wash water used in the plant will no longer have any mud or clay or stones settling out of the water into the pipes, the pipe joints, the various valves and their controls, that will do damage to the sugar refinery process piping systems used in the raw juice and refined juice extraction process. The grower members of the numerous sugar beet cooperatives in The United States own 25 currently operating sugar refineries. A total of 35 sugar beet refineries have closed since 1974 due to consolidation of operations, production efficiency improvements in existing refineries, or loss of sugar beet acreage. There are presently 12 operating sugar cane mills in The State of Louisiana, 2 sugar cane mills in The State of Florida and two sugar cane mills in The State of Hawaii. The sugar beet growing states for the years 2005-2006 are:
California with 200 growers; 49,000 acres of sugar beets harvested with a total harvested tonnage of 1,862,000 tons of sugar beets with a 38 ton per acre yield of sugar beets.
Colorado with 620 growers; 39,000 acres of sugar beets harvested with a total harvested tonnage of 794,000 tons with a 20.1 ton per acre yield.
Idaho with 1,100 growers; 210,000 acres of sugar beets harvested, with a total harvested tonnage of 5,040,000 tons with a 24 tons per acre yield.
Michigan with 2,150 growers; 178,000 acres of sugar beets harvested with a total harvested tonnage of 3,204,000 tons with an 18 ton per acre yield.
Minnesota with 2,444 growers; 476,000 acres of sugar beets harvested with a total harvested tonnage of 8,854,000 tons with an 18.6 tons per acre yield.
Montana with 515 grower; 55,000 acres of sugar beets harvested with a total tonnage of 1,096,000 tons with a 19.6 ton per acre yield.
Nebraska with 515 growers; 42,000 acres of sugar beets harvested with a total harvested tonnage of 760,000 tons harvested with an 18.1 ton per acre yield.
North Dakota with 1,263 growers; 258,000 acres of sugar beets harvested with a total harvested tonnage of 4,799,000 tons harvested with a per acre yield of 18 tons per acre.
The State of Ohio and its total production is included with the State of Michigan total as the Ohio sugar beets are processed in Michigan.
The State of Washington with 10 growers; 4,000 acres of sugar beets harvested with a total tonnage of 150,000 tons with a per acre yield of 37.5 tons per acre.
The State of Wyoming with 584 growers; 36,000 acres of sugar beets harvested, with a total tonnage of 659,000 tons with a per acre yield of 18.3 tons per acre. The 18 sugar beet growing associations are listed as follows:
   The California Sugar Beet Growers Association, Two West Swain Road Stockton, Calif. 95207 telephone 209-477-596.
   The Colorado Sugar Beet Grower Association, 822 7th Street Suite 620 Greeley, Colo. 80631 telephone 970-352-6875.
   The Nebco Beet Growers Association, 59811 County Road T Haxun, Colo. 80731 telephone 308-287-2895.
   The Elwyhee Beet Growers Association, P.O. Box 818 Mountain Home, Id. telephone 208-587-3561.
   The Idaho Sugar Beet Growers Association, 802 West Bannock Street Suite 802 Mountain Home, Id. 83702-5815 telephone 208-343-0167.
   The Nyssa-Nampa Beet Growers Association, 525 Good Avenue P.O. Box 2723 Nyysa, Oreg. 97913 telephone 541-372-2904.
   The Michigan Sugar Company 4800 Fashion Square Boulevard Suite 300 Plaza N. Saginaw, Mich. 48604 telephone 989-799-7300.
   The Red River Valley Sugar Beet Growers Association 1401 32nd St. SW Fargo, N. Dak. 58103-3430 telephone 701-239-4151.
   The Southern Minnesota Beet Sugar Cooperative 83550 Country Road 21 Rennville, Minn. 56284 telephone 320-365-3354.
   The Big Horn County Sugar Beet Growers Association Route 1 Box 1090 Hardin, Mont. 59034 telephone 406-665-1074.
   The Montana-Dakota Beet Growers Association 3592 159th Avenue Northwest Fairview, Mont. 59221 telephone 701-744-5167.
   The Mountain States Beet Growers Association of Montana HC 73 P.O. Box 715 38 Muri Road Hysham, Mont. 59038 telephone 406-468-7313.
   The Nebraska Sugar Beet Growers Association 1120 T Street Gering, Nebr. 69341 telephone 308-436-8524.
   The Minn-Dak Farmers Cooperative 7525 Red River Road Wahpeton, N. Dak. 58075 telephone 218-287-9830.
   The Big Horn Basin Beet Growers Association 478 Road 8 RR 1 Powell, Wyo. 82435 telephone 307-754-2378.
   The Platte Valley Wyo-Braska Beet Growers Association 381 Goodrich Road Wheatland, Wyo. 82201 telephone 307-322-4010.
   The Washakie Beet Growers Association P.O. Box 17 1200 Hilltop Drive Worland, Wyo. 82401 telephone 307-347-8762.
   The Wheatland Sugar Beet Growers Association 604 Ayers Road Wheatland, Wyo. 82201 telephone 307-322-4706.

The following are sugar associations in the United States:
ASGA 1156 15th St. NW Suite 1101 Washington, D.C. 20005 telephone 202-833-2398.
   USBSA 1156 15th St. NW Suite 1019 Washington, D.C. 20005 telephone 202-296-4820.
   ASA 2111 Wilson Blvd., Suite 600 Arlington, Va. 22201 telephone 703-351-5055.
   BSDF 800 Grant St. Suite 300 Denver, Colo. 80203 telephone 303-832-4460.
   Sugar Association Inc. 1101 15th St. NW, Suite 600 Washington, D.C. 20005 telephone 202-785-1122.

While I was researching the above figures obtained from the Sugar Producer magazine I also found out that the average amount of dirt entering a sugar factory according to a manager from Michigan sugar is ten percent of the total tonnage harvested so it is a considerable amount of dirt to deal with in the factory itself and that is why my patent is so important as it will remove all the dirt prior to the sugar beet or sugar canes entry into the sugar refinery for processing. The State of Louisiana has twelve currently operating sugar mills and the State of Hawaii has two operating sugar mills all of which I have listed below. The raw sugars from the two operating mills in Hawaii are refined in the State of California
Alma Plantation 4612 Alma Road Lakeland, La.; telephone; 225-627-9585. e-mail David Stewart@Bellsouth.net.
Cajun Sugar Cooperative, Incorporated P.O. Box 13940 New Iberia, La. 70562-3940 telephone 337-365-7820 e-mail Tommy@Cajun Coop.com.
Cora-Texas Manufacturing Company Incorporated P.O. Box 280 White Castle La. 70788; telephone 225-545-8360 e-mail Buckley@CoraTexas.com Web site; CoraTexas.com
Enterprise Factory Patoutville, La. M. A. Patout & Son Limited 3512 J. Patout Burns Road Jeanerette, La. 70544. Telephone 337-276-4592 e-mail ccaillier@mapatout.com
Lafourche Sugar Corporation 141 Leighton Quarters Road Thibodaux, La. 70301 e-mail GN.Lafourche@charter.net.
Lula Sugar Factory 351 Highway 999 P.O. Box 69 Belle Rose, La. 70341 telephone 225-473-9293 e-mail MDaigle@luwest.com.
Raceland Sugar Factory P.O. Box 159 Raceland, La. 70394-0159 telephone 985-537-4645. e-mail maryRRsc@aol.com
South Louisiana Sugars Cooperative P.O. Box 67 St. James, La. 70086 e-mail stjamescoop@eatel.net. web site: slscoop.com
St. Mary Sugar Cooperative Incorporated P.O. Box 269 Jeanerette, La. 70544 telephone 337-276-6761 e-mail rquillot@stmarysugar.com
Sterling Sugars, Incorporated. P.O Box 572 Franklin, La. 70538 telephone 337-828-0620.
Louisiana Sugar Cane Cooperative Incorporated LASUCA 6092 Resweber Highway St. Martinville, La., telephone 337-394-3255 web site LASUCA.com
Westfield Sugar Factory 451 Highway 1005 P.O. Box 10 Paincourtville, La. 70391 telephone 985-369-6450 e-mail CMatt@luwest.com
   State of Hawaii sugar mills Include the sugar mill on the Island of Kauai that is owned and operated by Gay & Robinson Incorporated. The sugar cane mill on The Island of Maui is owned and operated by the Hawaiian Commercial and Sugar Company.
   The raw sugars produced by these two mills are refined by a factory located at Crokett, Calif.

### SUMMARY

In accordance with the present new use patent invention a sugar beet and sugar cane pre-cleaning flume comprises, a stainless steel flume open at both ends with ultrasonic emitters on both sides and the bottom of the stainless steel flume lining the full length of the side walls and lining the floor length of the stainless steel flume.

### Objects and Advantages

Accordingly, besides the objects and advantages of the ultrasonic sugar beet and sugar cane cleaning flume described in my above patent, several objects and advantages are:
(a) To provide a very effective method of efficiency and more effectively cleaning method of harvested sugar beets prior to stockpiling and long term storage at the piling stations and sugar beet factories.
(b) To provide a method of removing all dirt and bacteria from the sugar beet and chopped sugar cane.
(c) To remove all dirt from the sugar beet that will act as an insulator which will reduce the storage life of the topped sugar beet root.
(d) To increase any sugar beet farmer's income by eliminating the dirt tare weight discount prior to weighing the beet loads at the sugar beet piling stations and the sugar beet factories.
(e) To remove the average 10 percent of crop tonnage weight from the field dirt brought into the beet factory or sugar cane mill process water from the sugar beet crop and chopped sugar cane.
(f) To eliminate the dirt load that has to be removed from the process water used in the sugar beet factory and sugar cane mill during its operation.
(g) To eliminate the excess wear from dirt in beet pumps, sugar cane pumps, and raw sugar juice piping systems.
(h) To reduce wear on sugar beet slicers, sugar cane crushers, and sugar cane grinders from dirt, mud and clay soils.
(i) To reduce the sugar refineries in plant maintenance expenditures relating to dirt mud and clay entering the pumping and processing machineries.

Wherein my new use patent invention utilizing ultrasonic energy much more thoroughly cleaning the topped sugar beets, and chopped sugar cane cuttings using the air bubbles, and sound waves created by the ultrasonic waves generated and carried by the water will vibrate the dirt and bacteria off of the sugar beet root and cane cuttings. Doing this obtains a superior cleaning on the sugar beet root prior to stockpiling, and removes the dirt clinging to the sugar beet root, whereby it increases the storage life of the sugar beet root, by eliminating any clinging dirt or clay that will retain the residual heat present in the sugar beet root immediately after harvest. By eliminating the dirt clinging to the sugar beet roots prior to stockpiling, it will eliminate any chance of premature decomposition by overheating of the beet root due to any clinging dirt acting as an insulator which retains the sugar beets naturally stored heat and reduces the natural sugars present in the beet root. The elimination of the residual dirt clinging to the sugar beet root will therefore allow the beet root to cool down much faster in the stockpile and it will improve its storage life in the stock pile prior to processing. The act of slicing the sugar beets or what it is referred to in the sugar beet trade as the slicing campaign, may begin early when the beet harvest is substantial or when the harvest is nearly complete in the area where the sugar factory is located. During this time several front end loaders are used to continually load the topped beets into the growing stock piles at the factory and piling stations, and also into the receiving hopper at the sugar factory where the topped dirty sugar beet enters the sugar beet factory for slicing and extraction of the raw sugars, molasses, and beet pulp. After the raw sugars are extracted they are stored the silo or silos at the sugar factory to await further processing. During the around the clock operation of the sugar factory the front end loader operator on duty must also load the limestone used to create the milk of lime solution in the sugar factories lime hoppers for mixing the milk of lime solution as well. The front-end loader operator also must load coal into the factory boilers for both the generation of electricity used in the factory and to make the hot water used to extract the raw sugars from the sugar beet noodles and provide heat energy for the sugar dryers, this is the name given to the sugar beet slices as they look like a wavy noodle. This enhances the ability of the milk of lime solution to extract more of the raw juices from the sugar beet slices as the act of slicing ridges or waves into the beet slices acts to increase the amount of surface area that can be penetrated by the milk of lime solution used to extract more useable raw sugar juice in the milk of lime solution. After most of the raw juice is extracted from the beet noodle's trip through the diffusing tanks containing the hot milk of lime solution, the slices are pressed to remove all the liquid and dried in a beet pulp drier. They are then sent to a pelleting machine; then excess juice is pumped back to the diffuser for further sucrose extraction.

### DRAWING FIGURES

FIG. 1 shows the complete sugar beet and chopped sugar cane cleaning system with atop view that is not drawn to scale and not illustrating the plumbing for water cleaner screener which is simply one water intake hose and one return line hose for the cleaned water. FIG. 1 also illustrates an end view of the stainless steel flume illustrating the first three of the numerous ultrasonic emitters mounted to the walls and floor of the stainless steel flume. The wiring conduits on the stainless steel flume and waterproof wiring to each emitter is not illustrated in the drawing. The end view also illustrates one set of the stainless steel support legs used to support the flume. Each set of stainless steel support legs has stainless steel cross members to strengthen each leg set. The support legs, leg cross members and the stainless steel flume are welded with stainless steel welding rod and the legs are welded to the bottom of the flume as well.

FIG. 2 is the flow chart for operating the cleaning system

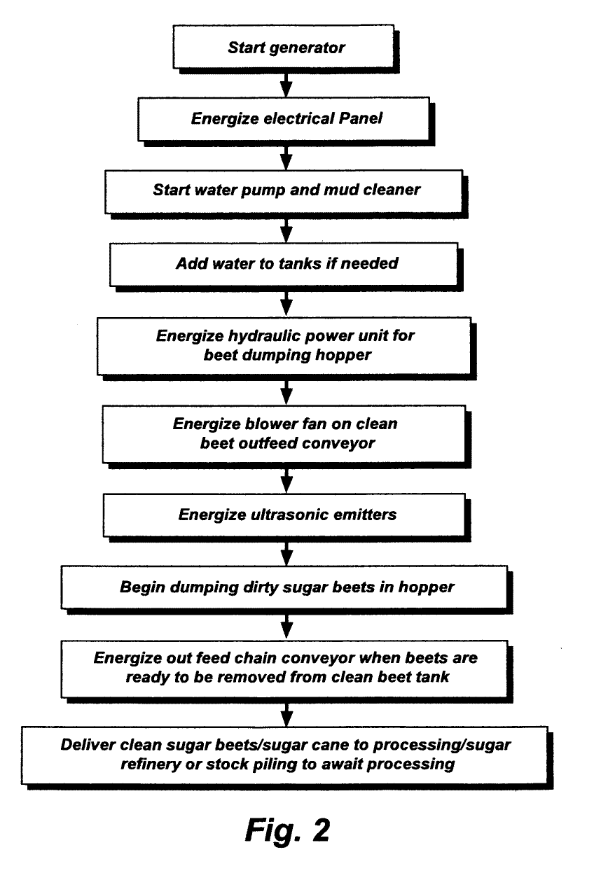

### REFERENCE NUMERALS IN DRAWING

1. Water filled receiving tank for dirty sugar beets and chopped sugar cane.
1a. Water filled clean beet/clean sugarcane cuttings receiving tank.
2. In-tank stainless steel baffles to direct the flow of the topped sugar beets and sugar cane cuttings.
3. Receiving hopper for topped dirty sugar beets, and sugar cane cuttings.
4. Side walls of stainless steel flume.
4a. End view of the plurality of ultrasonic emitters attached to the sidewalls and bottom of the flume.
5. Overhead view of the open chain conveyor used to transport the cleaned topped sugar beets.
5a. Exposed and hidden conveyor support legs.
5b. Air directing hood installed over the chain conveyor used direct heated or unheated air over cleaned and topped sugar beets.
5c. The blower or blowers used to dry the topped cleaned sugar beets.
5d. The unexposed drip pan used to collect the water dripping off the cleaned beets and returns it to the clean sugar beet receiving tank.
6. Bottom of receiving hopper.
7. Top view of the fully retracted pusher plate used to push dirty sugar beets and cane cuttings into the dirty sugar beet/cane receiving tank.
8. Top view of hydraulic cylinder used to propel and retract pusher plate used to deliver dirty beets and sugar cane cuttings to the water filled receiving tank.
9. Electrically powered hydraulic power pack used to power the double acting hydraulic cylinder used to propel and retract the pusher plate in the receiving hopper.
10. Three-phase diesel powered electric generator with an integral fuel tank and separate transformer for remote site electricity to provide power for overhead night lighting, electric power for the out-feed conveyor, hydraulic power pack, ultra sonic emitters, make up water pump, blower fans, hot air furnace, wash water cleaner-dirt screener with de-silting cones and or an office trailer.
11. Weather and water proofed electrical panel and electrical transformer.
12. Water make up tank to refill and drain both the dirty beet/sugar cane receiving tank and clean beet/sugar cane tank when replacing defective emitters in the stainless steel flume as needed.
13. Stainless steel support legs and stainless steel cross members for rigidity.

### Objects and Advantages

My new use patent method using ultrasonic energy for the cleaning of sugar beets, and cut sugar cane cuttings will allow full and complete cleaning of the topped sugar beet root, and chopped sugar cane using the tiny air bubbles created by the generation of ultrasonic energy, which will scrub the dirt off the topped sugar beets and cut cane prior to their being directly stockpiled or in the case of chopped sugar cane conveyed to the sugar cane mill for immediate processing. The dirt removed will fall away from the floating sugar beets and chopped sugar cane and settle to the bottom of the clean beet receiving tank after its trip through the stainless steel cleaning flume. The dirty water, mud, clay, and stones are vacuumed up by the mud cleaner suction pump and delivered to the mud screener/de-silting cleaner for separation, de-cleaner suction pump and delivered to the mud screener/de-silting cleaner for separation, de-silting with de-silting cones and screening the stones and larger debris out of the water flowing through the mud cleaner de-silter. The cleaned water is pumped back to the dirty beet receiving tank and used again to carry the beets and cane through the flume for cleaning. In the case of topped cleaned sugar beets, the open-chain conveyor lifts the cleaned and topped sugar beets out of the clean sugar beet receiving tank, where the beets move directly under a blower or blower hoods to dry, and or strip the water off the washed beets with or without pre-heated air. All of the cleaning occurs prior to weighing the beets at the piling station stockpile or at the sugar refinery stockpile. The open chain conveyor has a drip pan under the conveyor to collect all the water stripped by the blower or blowers and the water falls by gravity back to the tank from the drip pan and it is reused saving water. The elimination of the dirt from the sugar beet root or cane chopping will reduce the wear and tear on process piping, plumbing, pressure gauges, boiler heat exchangers, waste water piping, pipe joints, pipe elbows, The beet slicing machines, cane slicers and cane crushers, in the case of beet slicers the sugar beets enter from the top of the slicer using gravity to feed the beets to the slicers and the slicers cut the beets and the slices are delivered to the diffusers where the raw juice is extracted using the hot milk of lime solution. Each slicing knife section is individually bolted in place in the slicer assembly. When the slicer knives become dull the slicer must be shut down to replace the dull knives with sharp ones during the slicing campaign to maintain high production rates of beet noodles for raw sugar juice extraction. The pre-cleaning of the topped sugar beets with my new use patent method of ultrasonic cleaning for the removal of dirt from topped sugar beets and sugar cane cuttings prior to their entry into the sugar beet factory, or sugar cane mill will reduce slicing knife wear to zero as all the dirt and stones and debris will have been removed. Each individual Sugar beet knife section is ground to create a noodle edge on the sugar beet The diffusers will not have to contend with the dirt the machines normally collect during operation, as it will already have been removed and stripped away by the ultrasonic cleaning of the topped beet root or sugar cane cuttings and grindings. The heated milk of lime solution used to extract the raw sucrose juice will remain cleaner as the dirt will have been already removed. Thus the heated milk of lime solution will be better able to extract more raw sucrose juice during the diffusion process.

### Operation

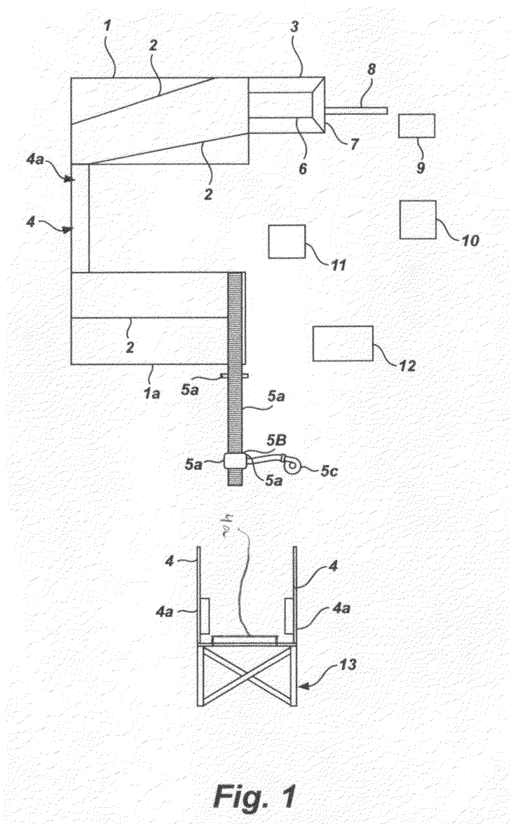

The ultrasonic powered sugar beet and cut sugar cane cleaning method using a stainless steel flume cleaning system using water as a conveying method to move the topped sugar beets for cleaning and ultrasonic energy to clean the topped sugar beets prior to stock piling or delivery directly to the sugar factory and sugar cane cuttings prior to their direct processing in a sugar cane mill. Sugar cane is a crop that can not be successfully stock piled in its raw, cut, harvested form as it deteriorates rapidly after harvesting. The over head view in FIG. 1 shows a simple horseshoe layout to allow a more efficient flow of receiving dirty beets and cane and the discharge of the cleaned topped sugar beets and chopped sugar cane. A linear installation is also possible of the entire system utilizing more stainless steel in tank baffles to direct and narrow the flow pattern of the plant material. The truck load of topped dirty sugar beets or cut sugar cane is dumped into the receiving hopper 3 where it is pushed into the dirty beet/cut sugar cane receiving tank 1 by the full width pusher plate 7 in the receiving hopper. The returning clean water flow created by the water-pump of the water screener and de-silter is used to push the floating beets and cut sugar cane to the end of the receiving tank using the in-tank stainless steel baffles 2 as a guide to the stainless steel flume. The topped beets and sugar cane cuttings enter the flume 4 where the dirt, mud, clay and bacteria is completely scrubbed flume. The topped beets and sugar cane cuttings enter the flume 4 where the dirt, mud, clay and bacteria is completely scrubbed off of the sugar cane cuttings and topped sugar beets by the microscopic bubbles created by the ultrasonic emitters 4a prior to their exiting of the flume. The cleaned sugar beets and sugar cane cuttings continue their way out of the flume into the clean beet and cane-receiving tank la. The dirt having fallen away from the topped sugar beets and sugar cane is flushed out by the water flow through the flume into the clean beet-sugar cane receiving tank at the same time. The dirt falls out of the flume and is vacuumed up by the water screener cleaner's intake hose at the base of the flume. The dirty water and debris is pumped to the screener de-silter for cleaning and pumped back to the dirty beet/cane receiving tank where it is reused to convey the topped sugar beets and cane cuttings. The cleaned beets or cut sugar cane continue to float until they reach the second stainless steel baffle 2 where they are pushed by water flow along its edge to the open-chain conveyor 5 to removal. In the case of sugar cane cuttings the conveyor would be a rubber belted conveyor that would deliver the cane cuttings into the sugar mill directly as they must be ground and processed immediately. The cleaned topped sugar beets travel up the conveyor until they pass under the blower hood 5b or hoods 5b with a high volume of heated or unheated air from the blower or blowers 5c to strip the water off the cleaned beet prior to stock piling or delivery to the sugar refinery for processing. The water removed from the beets by the blower or blowers is directed to the drip pan below the conveyor where it falls back to the clean beet cane cuttings tank 1a for reuse.

I claim:

1. A method for the more efficient cleaning of topped whole sugar beet pieces and chopped sugar cane prior to the extraction of raw sucrose juices, and sugar byproducts including molasses comprising of:
a. A plurality of ultrasonic emitters generating small air bubbles in water to scrub the topped sugar beets, sugar beet pieces, sugar beet slices, sugar beet noodles and chopped sugar cane of dirt, mud, clays and bacteria prior to their processing.
b. A narrow stainless steel water flume containing ultrasonic emitters lining the side walls and lining the floor of the flume, whereby a flowing current of water is used to clean and convey topped whole sugar beets, sugar beet pieces, sugar beet noodle slices through the flume, whereby said ultrasonic energy generated by and emitted from the ultrasonic emitters lining the sides and bottom of the stainless steel flume into the water is used to clean the topped sugar beets, sugar beet pieces, sugar beet noodles, sugar beet slices, and chopped sugar cane pieces, whereby the act of ultrasonic cleaning removes the dirt, mud clay, stones, debris, and natural bacteria adhering to the topped sugar beet, sugar beet pieces, sugar beet slices, sugar beet noodles, and chopped sugar cane.
